(19) United States
(12) Patent Application Publication
(10) Pub. No.: US 2023/0122709 A1
(43) Pub. Date: Apr. 20, 2023

(54) Bathroom Mat

(71) Applicants: Regina Stafford, Horsham, PA (US); Charles Stafford, Horsham, PA (US)

(72) Inventors: Regina Stafford, Horsham, PA (US); Charles Stafford, Horsham, PA (US)

(21) Appl. No.: 18/046,660

(22) Filed: Oct. 14, 2022

Related U.S. Application Data
(60) Provisional application No. 63/256,144, filed on Oct. 15, 2021.

(51) Int. Cl. A47G 27/02; A47K 3/00

(52) U.S. Cl. CPC A47G 27/0225; A47K 3/002

(57) ABSTRACT

The present invention relates generally to the field of home decor. More specifically, the present invention relates to a bathroom mat, carpet, or flooring accessory. The device has a body, a top surface, a bottom surface, and side edges forming a perimeter. The bottom surface has at least one grip area or fastener. In differing embodiments, the device may have a multitude of elements such as a heating element, a speaker, a light source, and/or at least one battery. In another embodiment, the device may further function as a scale and have at least one pressure sensor, at least one processor, a digital display, and at least one transmitter. The user's body weight may further be electrically communicated with a mobile application and allow a user to track their body weight via their smart device.

### CROSS-REFERENCE TO RELATED APPLICATION

The present application claims priority to, and the benefit of, U.S. Provisional Application No. 63/256,144, which was filed on Oct. 15, 2021, and is incorporated herein by reference in its entirety.

### FIELD OF THE INVENTION

The present invention relates generally to the field of home decor. More specifically, the present invention relates to flooring and accessories such as a bathroom mat. The device includes a body, with a top surface and a bottom surface. The bottom surface has at least one grip or non-slip area and at least one fastener. In differing embodiments, the invention may have a multitude of elements such as, at least one heating element, at least one speaker, at least one light source, and/or at least one battery. In another embodiment, the invention may further function as a scale and have at least one pressure sensor, at least one processor, at least one digital display, and at least one transmitter. The user's body weight may further electrically communicate with a mobile application to allow a user to track their body weight via their smart device such as a phone, tablet, or computer. Accordingly, the present disclosure makes specific reference thereto. Nonetheless, it is to be appreciated that aspects of the present invention are also equally applicable to other like applications, devices, and methods of manufacture.

### BACKGROUND

Bathroom mats and other flooring accessories are used to prevent individuals from slipping on the wet surface when they get out of the shower, bath or other areas where there may be spills. Certain bathroom layouts restrict individuals from being able to cover the needed surface area with bathroom mats. Most bathroom mats are used for the toilet or for the shower and are usually sold in two-piece sets. In small bathrooms, the mats must be overlapped to cover the needed surface area. Overlapping mats can be an eyesore and cause individuals to choose only one mat, leading to slipping hazards due to the lack of mat area. In addition, the area of overlap creates a raised region which could create a tripping hazard. In small bathrooms, there may not be enough floor space to use multiple bathroom mats. This can lead to slipping hazards in the exposed surface areas.

Therefore, there exists a long-felt need in the art for an improved bathroom mat or other flooring accessory. Further, there exists a long-felt need in the art for a bathroom mat or flooring accessory that provides a mat for use around one or more plumbing fixtures as well as a shower mat in one convenient piece. There also exists a long-felt need in the art for a bathroom mat device or other flooring accessory that covers the floor on the outside of the shower, toilet, and other plumbing fixtures, such as a sink and bidet to prevent against slip and falls. Further, there exists a long-felt need in the art for a bathroom mat or other flooring accessory that can fit into smaller bathrooms and cover an area that is about equal to the length of the shower and other fixtures in the bathing area to cover the floor surface. There also exists a long-felt need in the art for an all-in-one bathroom mat or flooring accessory that clears up floor space in the bathroom, allowing individuals to maneuver around the bathroom more easily and in a safer manner.

The subject matter disclosed and claimed herein, in one embodiment thereof, comprises a bathroom mat or flooring accessory. The invention has a body, with at least one top surface, at least one bottom surface and side edges creating a perimeter. The bottom surface includes at least one gripping or anti-slip area, and/or at least one fastener to restrict the mat or accessory from slipping or moving when a user steps on it. Further, the body of the invention has one or more cut out areas that wraps around the toilet and other plumbing fixtures allowing for the mat or flooring accessory to extend the length of the shower while still being around the toilet and other plumbing fixtures.

In this manner, the bathroom mat or flooring accessory of the present invention accomplishes all of the foregoing objectives and provides a novel bathroom mat or other flooring accessory that eliminates the need for multiple mats or carpet. Further, the present invention allows a user to have uncluttered floor space and eliminates slipping hazards in the bathroom.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bathroom mat or other flooring accessory to provide protection to the user as well as the floor surface. The device has a body, with a top surface, a bottom surface, side edges forming a perimeter and at least one area for securing the mat or accessory in position on the floor. The bottom surface of the body includes a gripping or anti-slip area. The grip or anti-slip area is preferably a textured non-slip material which may be provided in one or more patterns to enhance the anti-slip properties. In another embodiment, the bottom surface is the same material as the top surface but has at least one fastener located on the bottom surface, such as suction cups to hold the mat or flooring accessory in position. The grip or anti-slip area or the fasteners prevent the device from slipping out from under the user when they step onto the device.

The top surface of the body is preferably manufactured from a water-resistant material. In another embodiment, the top surface may be produced from any textile material in the art. Further, the top surface may be any color or pattern known in the art. The device includes at least one cut out which is sized and configured to fit around a plumbing fixture such as a toilet, bidet, sink or other item. The cut out allows the device to be formed or shaped around the base of the fixture so no open floor area is exposed. The cut out further provides the user with a way to line up the mat or other accessory in the bathroom.

The invention may have at least one heating element and at least one battery. The heating element allows for the mat or flooring accessory to be heated so that when the user steps out of the shower or bath and onto the device, they are greeted by a warm surface in the winter months or on cold mornings. The heating element may be powered by at least one battery. In another embodiment, the device may include at least one speaker. The speaker may be in electrical communication with the user's smart device via Wi-Fi, Bluetooth, or cellular data to play the users desired music, or other audio entertainment. In the preferred embodiment, the speaker is waterproof in that the speaker will not be damaged by moisture encountered in the bathroom area. The speaker is further powered by at least one battery.

In one embodiment, the device has at least one fastener or other securing aid which is positioned on the side edge or perimeter of the body. This fastener, or other securing assembly, can be released to allow the user to be able to remove the mat for cleaning, servicing, or reorienting. This allows the user to be able to remove or service the heating element or any other electrical devices in order to be able to wash the device. In another embodiment, the mat or flooring accessory may have at least one light source which is positioned along the top surface or perimeter of the body. The light source provides a user with the ability to see if the lighting in the bathroom is poor or to easily determine where the perimeter of the mat is when stepping out of the shower or tub. The light source is further powered by at least one battery. The lighting may be a single color or multiple colors and can be changed or personalized depending on the setting which an individual may choose on a smart device.

In another embodiment, the device may have at least one pressure sensor, at least one processor, at least one display screen, at least one transmitter, and at least one battery. When the user stands on the mat or flooring accessory, the pressure sensor registers the presence of the user and relays the individual's body weight to the processor via electrical communication. The processor is further in electrical communication with the display screen which allows the individual to view their body weight. The display screen can further display indicia such as the body weight, body fat percentage, historical weight readings, or show the battery life left of the device. The processor may also have a timer so that the display is not constantly on unless the individual wants the continuous display. The pressure sensor, processor, and the display screen are further powered by at least one battery. In small bathrooms or other areas, there may not be room to place a scale to allow a user to know their body weight. With the ability of the device to track and measure the user's body weight, more space in the bathroom is available for easier maneuverability.

In another embodiment, the mat or flooring accessory may have a transmitter that is in electrical communication with the pressure sensor. When the pressure sensor reads the individual's body weight, it relays the information to the transmitter which further relays it to the user's mobile application on their smart device via electrical communication. In this embodiment, the body weight of the individual or different members of a family or occupants of the residence is tracked and cataloged on the user's smart device via mobile application. A user can then keep a detailed record of their body weight. In one embodiment, the mobile application will track the current body weight of the user. In another embodiment, the mobile application will track the most recent previous body weight determinations of the user. In another embodiment, the mobile application tracks the current weight, most recent weight, as well as the average body weight for the past month or other period of time so that an individual can monitor their weight gain or loss of a period of time. This allows a user to stay on top of unwanted or needed weight gain or loss by viewing a detailed record of their body weight.

Accordingly, the bathroom mat or flooring accessory of the present invention is particularly advantageous as it allows a user to have an all-in-one bathroom mat or flooring accessory that eliminates the need to have multiple mats or carpets in smaller bathrooms or other small rooms. This allows a user to cover more floor space and prevent against slipping hazards or inadvertent movement of the carpet or mat. In this manner, the bathroom mat, carpet or flooring accessory overcomes the limitations of existing mats known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a bathroom mat, carpet or flooring accessory of the present invention in accordance with the disclosed specification;

FIG. 2 illustrates a perspective view of one potential embodiment of a bathroom mat, carpet or flooring accessory in use of the present invention in accordance with the disclosed description;

FIG. 3A illustrates a perspective view of one potential embodiment of a bathroom mat, carpet or flooring accessory in use of the present invention in accordance with the disclosed specification;

FIG. 3B illustrates a perspective view of one potential embodiment of a bathroom mat, carpet or flooring accessory of the present invention and having different lighting areas created by the programmable lighting source as well as localized heating areas in accordance with the disclosed specification;

FIG. 4 illustrates a graphical view of one potential embodiment of a mobile application of one potential embodiment of a bathroom mat, carpet or flooring accessory of the present invention in accordance with the disclosed specification; and

FIG. 5 illustrates a block diagram for a method of making a mat, carpet, or flooring accessory of the present invention in accordance with the disclosed specification.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved bathroom mat, carpet, or flooring accessory. Further, there exists a long-felt need in the art for a bathroom mat, carpet, or flooring accessory that provides coverage for a plumbing fixture as well as a shower mat. There also exists a long-felt need in the art for a bathroom mat, carpet, or flooring accessory that covers the floor on the outside of the shower or bathtub and toilet or other plumbing fixture to prevent against slip and falls. Further, there exists a long-felt need in the art for a bathroom mat, carpet, or flooring accessory that can fit into smaller bathrooms or other rooms and extend the length of the shower or bathtub. There also exists a long-felt need in the art for an all-in-one bathroom mat, carpet, or flooring accessory that frees up floor space in the bathroom, allowing individuals to maneuver around smaller rooms, such as the bathroom, in an easy and safe manner.

The present invention, in one exemplary embodiment, includes a bathroom mat, carpet, or flooring accessory. The device has a body, with at least one top surface, at least one bottom surface and side edges forming a perimeter which extends around the body. The bottom surface has at least one grip or non-slip area, and/or at least one fastener to restrict the mat, carpet, or flooring accessory from slipping when a user steps on it. In one embodiment, the device may have at least one programmable heating element to heat the device when the bathroom is cold or if the individual wants a warm surface when exiting the shower or bathtub. The heating element is powered by at least one battery and can have different temperature settings. In another embodiment, the device may have at least one speaker that allows a user to listen to the entertainment of their choice while they are in the bathroom. In yet another embodiment, the device may have at least one programmable light source. The light source can provide additional light if a user's bathroom is poorly lit or if the individual wants light to mimic the audio entertainment selected on the smart device or just to provide a better target area in which to step. The programmable light source may extend around the perimeter of the body or alternatively may be provided only in different portions. In addition, different lighting zones may be created, such as around the toilet or sink, as well as step area around the shower or bathtub.

In yet another embodiment, the mat, carpet, or flooring accessory may function as a scale, providing an individual's body weight via a display screen. This allows a user more bathroom floor space by eliminating the need for a scale or other weight management device in the bathroom. The device may include a pressure sensor that registers the user's weight. The pressure sensor then relays the users body weight to the processor via electrical communication. The processor then relays the user's body weight to the display screen via electrical communication. In yet another embodiment, the device further includes a mobile application that is in electrical communication with the pressure sensor via a transmitter. The mobile application tracks and records the user's body weight.

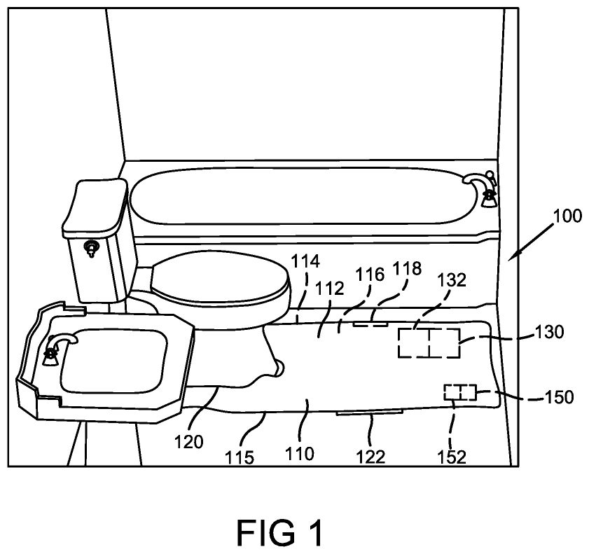

Referring initially to the drawings, FIG. 1 illustrates a perspective view of one potential embodiment of a bathroom mat, carpet, or flooring accessory device 100 of the present invention in accordance with the disclosed specification. The device 100 is comprised of a body 110, with a top surface 112, a bottom surface 114, side edges defining a perimeter 115 and at least one fastener 118. The body 100 may be manufactured in any shape in the art but is preferably rectangular in shape. In addition, the user may select the particular dimensions of the mat, carpet, or floor covering based on the particular dimensions of the room where the invention is to be used. In differing embodiments, the body 110 may be any shape such as, but not limited to: square, circle, polygonal, etc. In addition, the body 110 may be shaped as any indicia such as, but not limited to: patterns, logos, emblems, images, symbols, designs, letters, numbers, words, characters, insects, advertisements, brands, etc., to give the body 110 a themed appearance. The device 100 also may be any size known in the art but is preferably between 38 inches to 40 inches in length and 22 inches to 24 inches in width. The programmable elements may include a heating element, lighting or illumination features, a speaker, and a scale.

The bottom surface 114 of the body 110 includes a gripping area 116. The grip or non-slip area 116 is preferably a patterned or textured non-slip material such as, but not limited to: silicone, ethylene-propylene, natural rubber, nitrile, neoprene, butyl, polyvinyl chloride, or combinations thereof and creates a pattern having a height ranging from ⅛″ to ½″. In another embodiment, the bottom surface 114 is the same material as the top surface 112 and includes at least one fastener 118 located on the bottom surface 114 such as suction cups. The grip area 116 or the fasteners 118 prevent the device 100 from slipping out from under the user when they step onto the device 100.

The top surface 112 of the body 110 is preferably manufactured from a water-resistant material such as, but not limited to: TPU, waxed cotton, nylon, polyester, laminated cotton, poplin, oilcloth, vinyl, wool, polyester fleece, or combinations thereof. In another embodiment, the top surface 112 may be manufactured from any suitable textile material in the art such as, but not limited to: microfiber, bamboo, cotton, rubber, plastic, teak, chenille, memory foam, silk, wool, canvas, linen, knit, latex, nylon, or combinations thereof. Further, the top surface 112 may be any color or pattern known in the art.

The device 100 may include at least one cut out 120. The cut out 120 allows the device 100 to be shaped around the base of a plumbing fixture such as a toilet, so no floor area is exposed. The cut out 120 further provides the user with a way to line up the device 100 in the bathroom.

The device 100 may have at least one heating element 130 and at least one battery 132. The heating element 130 allows for the device 100 to be heated so when the user steps out of the shower and onto the device 100, they are not cold in the winter months or in the morning. The heating element 130 may be any heating element known in the art such as, but not limited to: heated coils, heated wires, hot air, or combinations thereof. The heating element 130 may be powered by at least one battery 132 and may have different settings controlled by a thermostat. The settings may range from low, medium, or high and the thermostat may have a timer so that the heater is not constantly running. The heating element 130 may be placed at different portions of the mat or carpet and may be individually operated depending on where the individual is stepping. The battery 132 can be in the form of an alkaline, nickel-cadmium, nickel-metal hydride battery, or combinations thereof, such as any 3V-12-volt DC battery 132 or other conventional battery 132, such as A, AA, AAA, etc., that supplies power to the heating element 130. Throughout this specification the terms “battery” and “batteries” may be used interchangeably to refer to one or more wet or dry cells or batteries 132 of cells in which chemical energy is converted into electricity and used as a source of DC power. References to recharging or replacing batteries 132 may refer to recharging or replacing individual cells, individual batteries 132 of cells, or a package of multiple battery cells as is appropriate for any given battery 132 technology that may be used.

In another embodiment, the device 100 has at least one speaker 150. The speaker 150 may be in electrical communication with the user's smart device via Wi-Fi, Bluetooth, or cellular data to play the users desired music, or other entertainment. The speakers 150 may be any speaker known in the art. In the preferred embodiment, the speaker 150 is waterproof in that the speaker 150 will not get ruined by moisture. The speaker 150 is further powered by at least one battery 152. In a further embodiment, the speaker 150 may be integrated with the lighting feature 160 so that a particular lighting effect may be created by the individual.

In one embodiment, the device 100 includes at least one fastener 122 positioned on the side of the body 110. This fastener 122 can be undone to allow the user to be able to access inside the device 100. This allows the user to be able to remove the heating element 130, speaker 150 or any other electrical devices in order to wash the device 100. The fastener 122 may be any fastener such as, but not limited to, hook and loop, snap button, or preferably zipper.

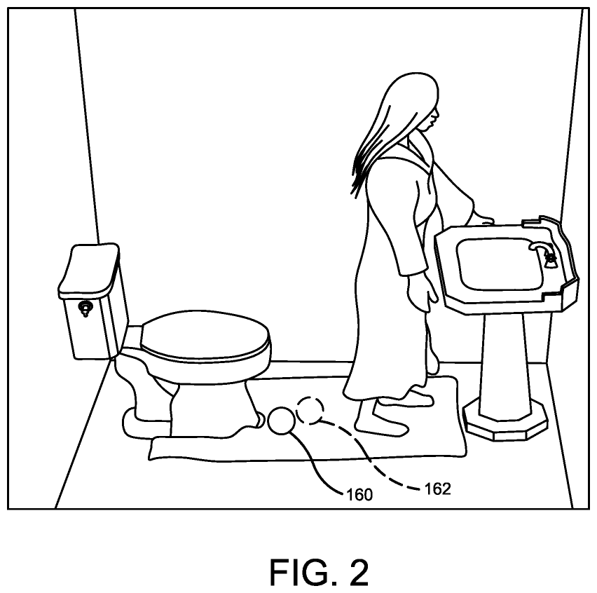

FIG. 2 illustrates a perspective view of one potential embodiment of a bathroom mat, carpet, or flooring accessory 100 in use of the present invention in accordance with the disclosed specification. In one embodiment, the mat, carpet, or flooring accessory 100 may have at least one light source 160 positioned along the top surface 112 of the body. The light source 160 provides a user with an ability to see if the lighting in the bathroom is poor, customize the lighting effects so to illuminate only certain areas of the carpet 100 or to create a personalized light show to correspond to the music or audio programs being listened to. There are a plurality of light sources 160 that may be used such as, but not limited to: LED, LCD, incandescent, fluorescent, halogen, light-emitting diode, or combinations thereof. The programmable light source 160 is further powered by at least one battery 162. The battery 162 may further be any battery known in the art. A smartphone 181 is wirelessly connected to the bathroom carpet 100 and contains one or more downloaded applications to manage one or more programmable elements, such as a scale, lighting element, speaker or heating element or combinations of programmable elements.

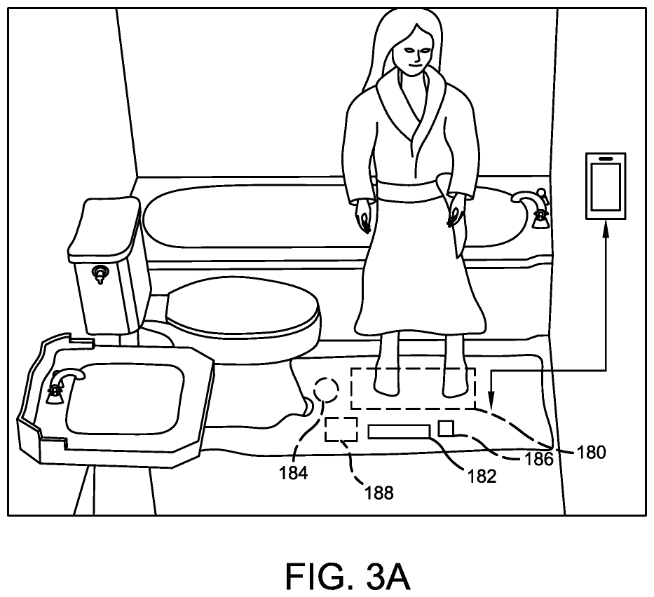

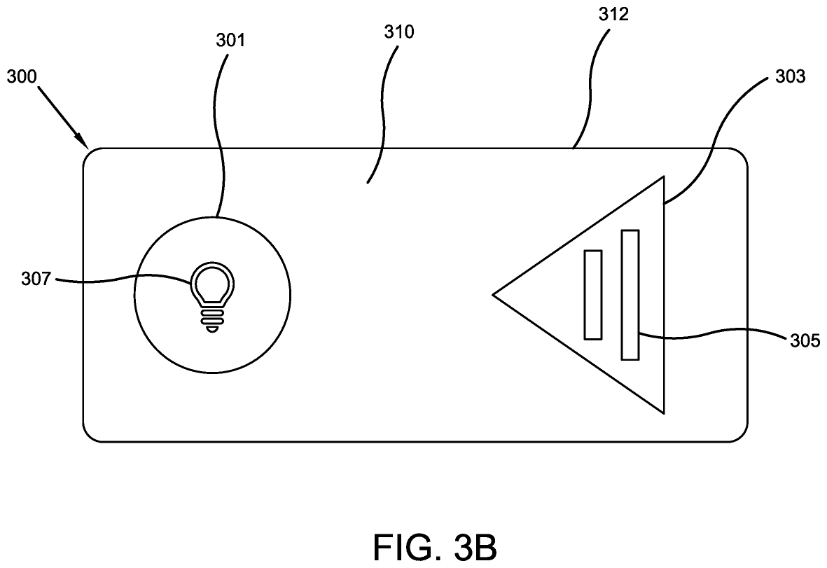

FIG. 3A illustrates a perspective view of one potential embodiment of a bathroom mat in use of the present invention in accordance with the disclosed specification. In one embodiment, the mat, carpet, or flooring accessory may have at least one pressure sensor 180, at least one processor 184, at least one display screen 182, at least one transmitter 188, and at least one battery 186. When the user stands on the device 100, the pressure sensor 180 senses the user and relays the user's body weight to the processor 184 via electrical communication. The processor 184 is further in electrical communication with the display screen 182 which allows the user to view their body weight. In small bathrooms, there may not be room to place a scale to allow a user to know their body weight. With the ability of the device 100 to track and measure the user's body weight, more space in the bathroom is available for easier maneuverability.

The pressure sensor 180 may be any pressure sensor known in the art. The display screen 182 may be any screen such as, but not limited to: LCD, LED, micro-LED, OLED, etc. The display screen 182 can further display indicia such as the user's body weight, body fat percentage, historical information, data from different users, or show the remaining battery life of the device 100. The pressure sensor 180, processor 184, and the display screen 182 are further powered by at least one battery 186. The battery 186 can be in the form of an alkaline, nickel-cadmium, nickel-metal hydride battery, etc., such as any 3V-12-volt DC battery 186 or other conventional battery 186, such as A, AA, AAA, etc. that supplies power to the pressure sensor 180, display screen 182, and processor 184. Throughout this specification the terms “battery” and “batteries” may be used interchangeably to refer to one or more wet or dry cells or batteries 186 of cells in which chemical energy is converted into electricity and used as a source of DC power. References to recharging or replacing batteries 186 may refer to recharging or replacing individual cells, individual batteries 186 of cells, or a package of multiple battery cells as is appropriate for any given battery 186 technology that may be used.

In another embodiment, the device 100 may include a transmitter 188 that is in electrical communication with the pressure sensor 180. When the pressure sensor 180 reads the user's body weight, it relays the data to the transmitter 188 which further relays it to the user's mobile application 200 on their smart device via electrical communication.

FIG. 3B illustrates the floor mat 300 having a top surface 310 with a perimeter 312, and first and second programmable areas 301 and 303, which are designated areas in the body of the mat, carpet, or floor accessory. The programmable areas 301 and 303 may have different features, such as a heating element 305 or lighting features 307. Each of the programmable areas 301 and 303 is manageable by a downloaded application operated from a smart device.

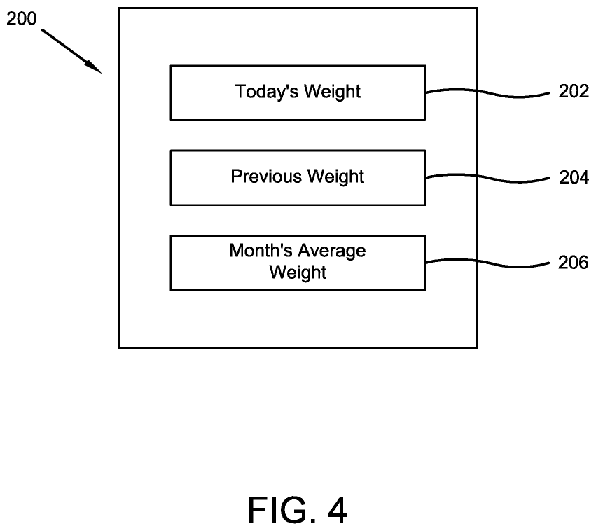

FIG. 4 illustrates a graphical view of one potential embodiment of a mobile application 200 of one potential embodiment of a bathroom mat, carpet, or flooring accessory 100 of the present invention in accordance with the disclosed specification. In one embodiment, the device 100 is a mobile application 200 that is in electrical communication with at least one pressure sensor 180 via a transmitter 188. In this embodiment, the user's body weight is tracked and cataloged on the user's smart device via a mobile application 200. A user can then keep a detailed record of their body weight. In one embodiment, the mobile application 200 will track the current body weight of the user 202. In another embodiment, the mobile application 200 will track the most recent previous body weight of the user 204. In another embodiment, the mobile application 200 tracks the current weight 202, most recent weight 204, as well as the average body weight for the past month 206. This allows a user to stay on top of unwanted weight gain or loss by viewing a detailed record of their body weight.

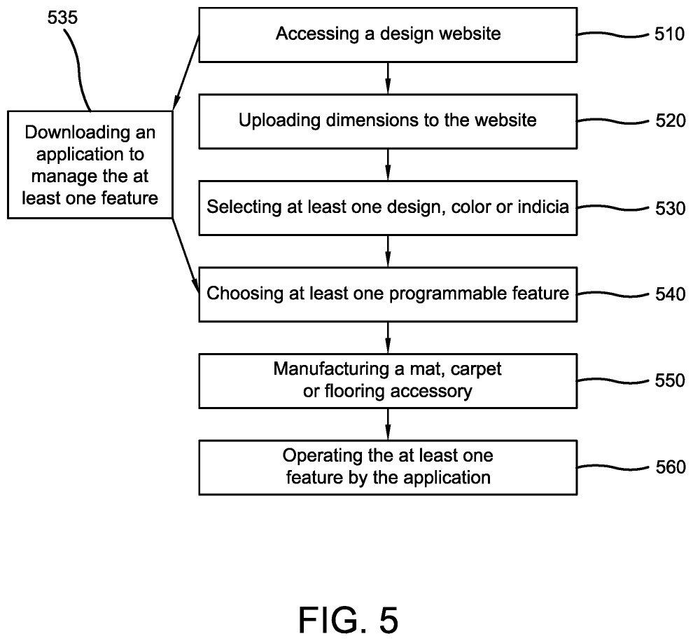

FIG. 5 is a flow diagram of a method of creating one of a floor mat, carpet, or flooring accessory and includes the steps of initially accessing a design website 510 via a smart device, such as a smartphone, computer or tablet, and then at step 520, uploading dimensions for a room for which the floor mat, carpet, or flooring accessory may be useful to the website. Next, at step 530, selecting at least one of a design, color, or indica and at step 540, choosing at least one feature to include with the carpet, floor mat, or flooring accessory. The at least one feature may be a scale, heating element, lighting element, or speaker. At step 550, the carpet, floor mat, or flooring accessory is manufactured, and at step 560, the at least one feature is provided by a downloaded application. The application may be downloaded at step 535, in order to provide the at least one feature management function.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “bathroom mat device” and “device” are interchangeable and refer to the bathroom mat device 100 of the present invention.

Notwithstanding the foregoing, the bathroom mat device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the bathroom mat device 100 as shown in the FIGS. are for illustrative purposes only, and that many other sizes and shapes of the bathroom mat device 100 are well within the scope of the present disclosure. Although the dimensions of the bathroom mat device 100 are important design parameters for user convenience, the bathroom mat device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A floor mat comprising:
a body having a top surface, a bottom surface, and a plurality of side edges forming a perimeter;
a gripping or anti-slip element provided on one of the bottom surface or the perimeter of the body; and
at least one programmable element included with the body.

2. The floor mat as recited in claim 1, wherein the at least one programmable element includes one of a scale, a heating element, a lighting element or a speaker.

3. The floor mat as recited in claim 1 further comprising a processor and a display.

4. The floor mat as recited in claim 2, wherein the at least one programmable element is connected to a battery.

5. The floor mat as recited in claim 1 further comprising a pressure sensor.

6. The floor mat as recited in claim 1, wherein the at least one programmable element is a scale, and the scale is in communication with a pressure sensor, a processor and a display.

7. The floor mat as recited in claim 1, wherein the at least one programmable element is removable from the body.

8. The floor mat as recited in claim 2, wherein the lighting element is provided around the perimeter of the body.

9. The floor mat as recited in claim 1, wherein the gripping or non-slip element is provided on the bottom surface of the body and is a patterned or textured non-slip material.

10. The floor mat as recited in claim 9, wherein the gripping or non-slip element is comprised of an ethylene-propylene, a natural rubber, a nitrile, a neoprene, a butyl, a polyvinyl chloride or a combination thereof, and creates a pattern having a height ranging from ⅛″ to ½″.

11. The floor mat as recited in claim 1, wherein the at least one programmable element is provided in a designated area of the body.

12. A bathroom carpet comprising:
a body having a front surface, a rear surface and a plurality of side edges forming a perimeter, and at least one cut out area to accommodate a plumbing fixture;
a grip or non-slip area having a pattern or texture positioned on the rear surface of the body;
a scale connected to a pressure sensor and a display, wherein the pressure sensor produces an information for the display; and
a battery for powering the scale, the display and the pressure sensor, wherein the scale is in wireless communication with a smartphone to collect weight information from a user.

13. The bathroom carpet as recited in claim 12, wherein the body further comprises a plurality of programmable elements including a scale, a heating element, a lighting feature and a speaker.

14. The bathroom carpet as recited in claim 13, wherein the programmable elements are powered by the battery and managed by the smartphone.

15. The bathroom carpet as recited in claim 13, wherein the programmable elements are provided in a designated area of the body.

16. The bathroom carpet as recited in claim 13, wherein the heating element is comprised of a thermostat, a timer and has ranges of low, medium and high.

17. The bathroom carpet as recited in claim 13, wherein the lighting feature can be integrated with the speaker to produce a particular lighting effect.

18. The bathroom carpet as recited in claim 13, wherein the pressure sensor and display are connected to a processor.

19. A method of making a bath mat, the comprising the steps of;
accessing a website;
uploading dimensions of a room;
selecting at least one design, color or indicia;
choosing at least one programmable feature;
manufacturing a mat, carpet or flooring accessory; and
operating the at least one programmable feature by a smartphone.

20. The method of making a bath mat as recited in claim 19 further comprising a step of downloading an application to manage the at least one programmable feature.
